(19) United States
(12) Patent Application Publication
(10) Pub. No.: US 2010/0294040 A1
(43) Pub. Date: Nov. 25, 2010

(54) CAPACITIVE SENSOR AND 3-AXIS GYROSCOPIC SENSOR UTILIZING CAPACITIVE SENSORS

(75) Inventor: JEN-TSORNG CHANG, Tu-Cheng (TW)

Correspondence Address: Altis Law Group, Inc.;ATTN: Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/617,880

(22) Filed: Nov. 13, 2009

(30) Foreign Application Priority Data
May 22, 2009 (CN) 200910302544.2

(51) Int. Cl. G01P 15/125

(52) U.S. Cl. 73/514.32

(57) ABSTRACT

An exemplary capacitive sensor includes a casing, a fixed electrode, a spring, a moveable electrode, and a capacitance measuring circuit. The casing includes a base and a cylindrical wall. The fixed electrode is disposed on the cylindrical wall and includes a fixed arm section and at least one fixed prong section, wherein at least one fixed prong section is curved and extends outwards from one side of the fixed arm section. The spring is disposed on the base. The moveable electrode is attached to the spring and includes a movable electrode section and at least one movable prong section, wherein at least one movable prong section is curved and extends outwards from one side of the movable arm section, and the movable prong section and the fixed prong section oppose each other. The capacitance measuring circuit is configured for measuring the capacitance between the fixed electrode and the movable electrode.

### BACKGROUND

1. Technical Field

The present disclosure relates to capacitive sensors, and to a 3-axis gyroscopic sensor utilizing capacitive sensors.

2. Description of Related Art

Capacitive sensors can be found in many popular consumer products such as laptop computers, media players, and mobile phones. Until now, capacitive sensors typically can measure a linear acceleration of a moving object in one direction. However, it is problematic for contemporary capacitive sensors to measure an angular acceleration of the moving object.

Therefore, there is room for improvement within the art.

### BRIEF DESCRIPTION OF THE DRAWINGS

FIG. 1 is a schematic, cross-sectional view of a capacitive sensor, according to the present disclosure.

FIG. 2 is a schematic, isometric view of the capacitive sensor of FIG. 1, which is used in a moving body.

FIG. 3 is a schematic, isometric view of a 3-axis gyroscopic sensor utilizing three capacitive sensors of FIG. 1.

### DETAILED DESCRIPTION

Embodiments of the present capacitive sensor and 3-axis gyroscopic sensor utilizing three capacitive sensors will now be described in detail with reference to the drawings.

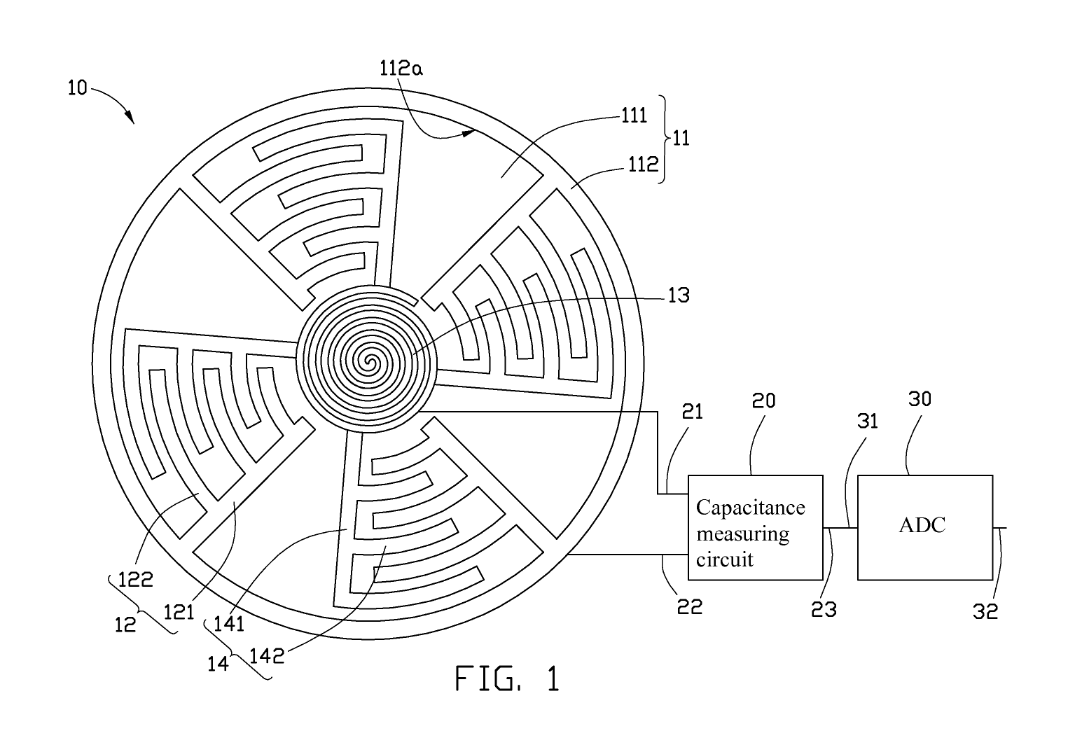

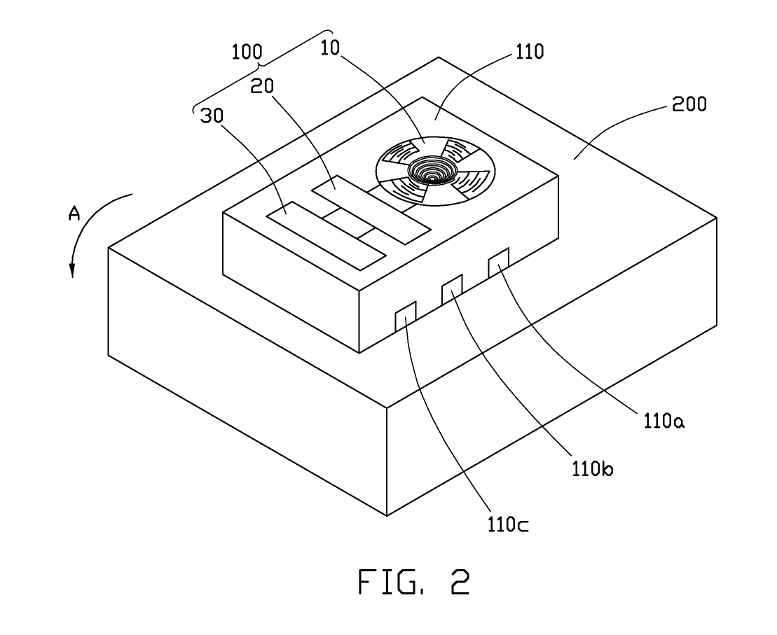

Referring to FIGS. 1-2, a capacitive sensor 100, according to an exemplary embodiment, is disposed on a moving object 200 and used to measure an angular acceleration of the moving object 200. The capacitive sensor 100 includes a sensing device 10, a capacitance measuring circuit 20, and an analog to digital convertor (ADC) 30.

The sensing device 10 is configured for converting a movement of the moving object 200 to a measureable parameter. In detail, the sensing device 10 includes a casing 11, at least one fixed electrode 12, a spiral spring 13, and at least one movable electrode 14. In this embodiment, the sensing device 10 is made of poly silicon material and is manufactured in a form of a micro electro mechanical system (MEMS).

The casing 11 is a barrel in shape, and includes a base 111 and a cylindrical wall 112. The base 111 is circular. The cylindrical wall 112 extends perpendicularly from an edge of the base 111, and includes an inner surface 112a.

Each fixed electrode 12 is generally comb shaped, and includes a fixed arm section 121 and three fixed prong sections 122. The fixed arm section 121 perpendicularly extends from the inner surface 112a, and extends radially inwards toward a center axis of the casing 11. The fixed prong sections 122 are curved, and extend from one side of the fixed arm section 121. The fixed prong sections 122b are parallel to each other, and spaced at predetermined distances apart from each other. In the illustrated embodiment, the fixed prong sections 122 are arc-shaped, and a pitch between adjacent fixed prong sections 122 is constant. The lengths of the fixed prong sections 122 gradually increase from the fixed prong section 122 nearest a center axis of the casing 11 to the fixed prong section 122 nearest the cylindrical wall 112. In this embodiment, four fixed electrodes 12 are employed and evenly distributed around the inner surface 112a. The fixed prong sections 122 of the fixed electrodes 12 all point in a clockwise direction as viewed in FIG. 1.

The spiral spring 13 is conical shaped, and fixed to the center of the base 111. The spiral spring 13 regains its original shape after being compressed or extended.

In general, each movable electrode 14 symmetrically matches the shape and size of each fixed electrode 12. Each movable electrode 14 includes a movable arm section 141 and three movable prong sections 142. The movable arm section 141 is perpendicularly attached to the spiral spring 13, and extends radially outwards from the center axis of the casing 11. The movable prong sections 142 are curved, and extend from one side of the movable arm section 141. The movable prong sections 142 are parallel to each other, and spaced predetermined distances from each other. In the illustrated embodiment, the movable prong sections 142 are arc-shaped, and a pitch between adjacent movable prong sections 142 is constant. The lengths of the movable prong sections 142 gradually increase from the movable prong section 142 nearest the center axis of the casing 11 to the movable prong section 142 nearest the cylindrical wall 112. The number of movable electrodes 14 corresponds to the number of fixed electrodes 12. In this embodiment, four movable electrodes 14 are employed. The movable electrodes 14 are attached to the spiral spring 13, and are evenly distributed around the spiral spring 13. The movable prong sections 142 of the movable electrodes 14 all point in a counterclockwise direction as viewed in FIG. 1. In particular, the four movable electrodes 14 are positioned so that the fixed prong sections 122 and the corresponding movable prong sections 142 are spaced from each other a distance.

The capacitance measuring circuit 20 is configured for measuring the capacitance between the fixed electrodes 12 and the movable electrodes 14. The capacitance measuring circuit 20 includes a first input terminal 21, a second input terminal 22, and an output terminal 23. The first input terminal 21 is electrically connected to the movable electrodes 14, and the second input terminal 22 is electrically connected to the fixed electrodes 12.

The ADC 30 is an electronic device that converts an analog voltage or current to a digital signal proportional to the magnitude of the voltage or current. The ADC 30 includes an analog signal terminal 31 and a digital signal terminal 32. The analog signal terminal 31 is electrically connected to the output terminal 23. The digital signal terminal 32 outputs the digital signal.

In assembly, the capacitive sensor 100 is packaged in a shell 110, and further includes a power terminal 110a, a ground terminal 110b, and a signal terminal 110c. The power terminal 110a is electrically connected to the capacitance measuring circuit 20 and the ADC 30. The ground terminal 110b is grounded. The signal terminal 110c is electrically connected to the digital signal terminal 32.

In use, the capacitive sensor 100 is secured to the moving object 200. When the moving object 200 moves along direction A depicted in FIG. 2, the fixed electrodes 11 move together with the moving object 200, and the moveable electrodes 13 tend not to move due to inertia. Areas where the fixed prong sections 122 and the corresponding movable prong sections 142 overlap are changed. If the moving object 200 spins clockwise, the capacitance of the capacitive sensor 100 increases. If the moving object 200 spins counterclockwise, the capacitance of the capacitive sensor 100 decreases. The angular acceleration of the moving object 200 is a function of a variation of the capacitance of the capacitive sensor 100.

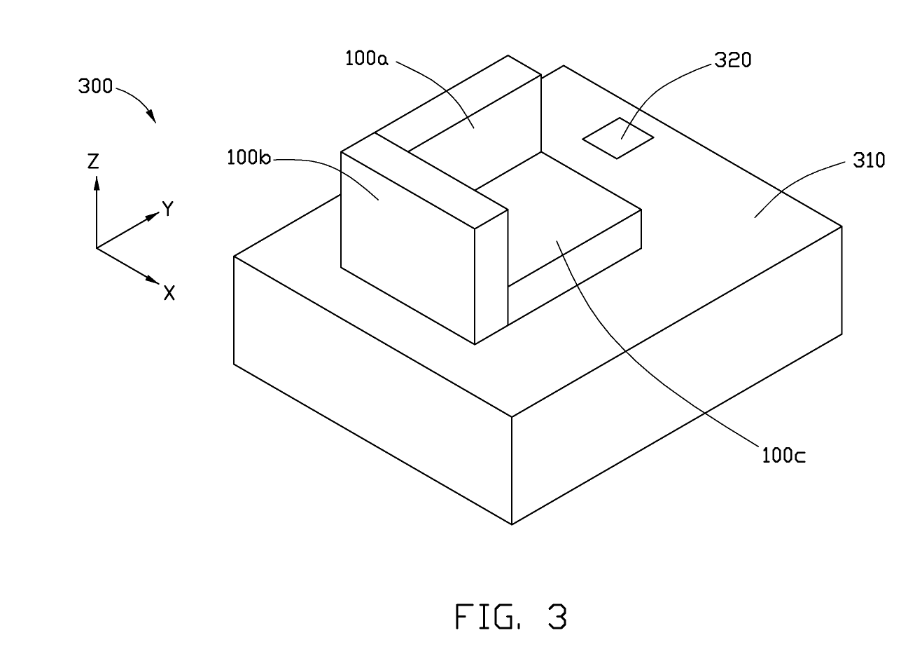

Referring to FIG. 3, a 3-axis gyroscopic sensor 300 used to measure the angular acceleration of a moving object 200 in three dimensions is shown. The 3-axis gyroscopic sensor 300 includes a loading plate 310, a circuit module 320, and three capacitive sensors 100a, 100b, 100c. Each of the capacitive sensors 100a, 100b, 100c is the same as the capacitive sensor 100. The capacitive sensors 100a, 100b, 100c are disposed on the loading plate 310 along X, Y, Z coordinate axis directions, respectively, and measure the angular acceleration in the X, Y, Z axis directions, respectively. The circuit module 320 is configured for processing the digital signals transmitted from the capacitive sensors 100a, 100b, 100c.

It will be understood that the above particular embodiments and methods are shown and described by way of illustration only. The principles and the features of the present invention may be employed in various and numerous embodiments thereof without departing from the scope and spirit of the invention as claimed. The above-described embodiments illustrate the scope of the invention but do not restrict the scope of the invention.

What is claimed is:

1. A capacitive sensor comprising:
a casing comprising a base and a cylindrical wall;
a fixed electrode disposed on an inside of the cylindrical wall and comprising a fixed arm section and at least one fixed prong section, wherein at least one fixed prong section is curved and extends from one side of the fixed arm section;
a spiral spring disposed on the base;
a moveable electrode attached to the spiral spring and comprising a movable arm section and at least one movable prong section, wherein at least one movable prong section is curved and extends from one side of the movable arm section, and at least one movable prong section and at least one fixed prong section oppose each other; and
a capacitance measuring circuit configured for measuring the capacitance between the fixed electrode and the movable electrode.

2. The capacitive sensor in claim 1, wherein the spiral spring is conical shaped and is fixed to the center of the base, and the spiral spring regains its original shape after being compressed or extended.

3. The capacitive sensor in claim 1, wherein each fixed electrode comprises three fixed prong sections, and lengths of the fixed prong sections gradually increase from the fixed prong section nearest a center axis of the casing to the fixed prong section nearest the cylindrical wall.

4. The capacitive sensor in claim 3, wherein each movable electrode comprises three movable prong sections, and lengths of each of the movable prong sections gradually increase from the movable prong section nearest the center axis of the casing to the movable prong section nearest the cylindrical wall.

5. The capacitive sensor in claim 1, further comprising an analog to digital convertor (ADC), configured for converting an analog signal to a digital signal.

6. A 3-axis gyroscopic sensor comprising:
a loading plate;
three capacitive sensors disposed on the loading plate, each capacitive sensor aligned substantially perpendicular to each of the other two capacitive sensors, each capacitive sensor comprising:
a casing comprising a base and a cylindrical wall;
a fixed electrode disposed on an inside of the cylindrical wall and comprising a fixed arm section and at least one fixed prong section, wherein at least one fixed prong section is curved and extends from one side of the fixed arm section;
a spiral spring disposed on the base;
a moveable electrode attached to the spiral spring and comprising a movable electrode section and at least one movable prong section, wherein at least movable prong section is curved and extends outwards from one side of the movable arm section, and at least one movable prong section and at least one fixed prong section oppose each other; and
a capacitance measuring circuit configured for measuring the capacitance between the fixed electrode and the movable electrode; and
a circuit module configured for processing the measuring capacitances transmitted from transmitted from the capacitive sensors.

7. The 3-axis gyroscopic sensor in claim 6, wherein the spiral spring is conical shaped and is fixed to the center of the base, and the spiral spring regains its original shape after being compressed or extended.

8. The 3-axis gyroscopic sensor in claim 6, wherein each fixed electrode comprises three fixed prong section, and lengths of each of the fixed prong sections gradually increase from the fixed prong section nearest a center axis of the casing to the fixed prong section nearest the cylindrical wall.

9. The 3-axis gyroscopic sensor in claim 8, wherein each movable electrode comprises three movable prong sections, and lengths of each of the movable prong sections gradually increase from the movable prong section nearest the center axis of the casing to the movable prong section nearest the cylindrical wall.

10. The 3-axis gyroscopic sensor in claim 6, further comprising an analog to digital convertor (ADC), configured for converting an analog signal to a digital signal.
